(19) United States
(12) Patent Application Publication
(10) Pub. No.: US 2019/0183724 A1
(43) Pub. Date: Jun. 20, 2019

(54) Apparatus, System and Method for Muscle Vibration Training, Tremor Inhibition and Rehabilitation

(71) Applicant: Daniel Joseph Sifferlin, Wooster, OH (US)

(72) Inventor: Daniel Joseph Sifferlin, Wooster, OH (US)

(21) Appl. No.: 14/990,140

(22) Filed: Jan. 7, 2016

Related U.S. Application Data
(60) Provisional application No. 62/262,063, filed on Dec. 2, 2015.

(51) Int. Cl. A61H 23/02

(52) U.S. Cl. CPC A61H 23/0218; A61H 2201/5005; A61H 2201/1207; A61H 2201/0157; A61H 2201/165

(57) ABSTRACT

A direct, non-pharmaceutical, non-invasive method of enhancing neurophysiological and musculophysiological muscle performance, muscle rehabilitation and recovery in specific target muscle(s) in users. Use of the system may provide inhibition of spastic neurotransmission tremors. The device, system, and method utilizes direct vibration stimulation of the specific target through the use and application of a fabric/nylon sleeve or wrap shaped to conform to the extremity or joint, shoulder, neck or head on which the target resides. The device applies vibrations to the target muscle group(s) at up to 100 Hz, with the vibration generating motor mechanism contained within the fabric/nylon sleeve or wrap.

### CROSS-REFERENCE TO RELATED APPLICATIONS

The Application claims priority to U.S. Provisional Patent Application Ser. No. 62/262,063, filed Dec. 2, 2015.

### STATEMENT REGARDING FEDERALLY SPONSORED RESEARCH

Not applicable.

### BACKGROUND

The present disclosure relates to a system, method, and apparatus for enhancing neurophysiological and musculophysiological performance, such as during exercise or training programs, by improving the function and recovery of muscle systems by pre-defined Total Body Vibration system modalities. The disclosure also relates to utilization for inhibition of spasmodic neurotransmission within the musculoskeletal system, such as those conditions caused by neurological disease or injury.

The achievement of improved and increased muscle strength and endurance, and protective rehabilitation therapy with reduced delayed-onset muscle soreness (DOMS) is the goal of every athlete. Even non-athletes pursue beneficial remedies for muscle aches and soreness.

Individuals afflicted with neurological disease or injury often experience spastic and uncontrolled neurotransmissions to their muscles resulting in uncontrolled and debilitating shaking motions of the extremities and head. Diskenesia, bradykinesia, and dystonia are additional motive disorders associated with neurological disorders that affect muscle movements. Certain diseases, such as Parkinson's Disease are associated with interference of typical body movements associated with disrupted function of neurotransmitters. Such individual patients would benefit from recovery of control of muscle function through the inhibition of spastic neurotransmissions, for instance, without utilizing drugs or by avoiding debilitating drug side effects. Such spastic and uncontrolled neurotransmitted muscle tremors can be found in millions of patients diagnosed with Parkinson's Disease and Benign Essential Tremors.

The ability to improve muscle strength, power, endurance, and flexibility, and to improve the ease and success of rehabilitation or recovery therapies without the use of drugs is desired. In addition, there is a continuing demand among athletes and non-athletes alike for treatment options that do not involve drugs that may result in unwanted side effects, utilize illegal and universally banned chemical substances or enhancers such as steroids, and otherwise provide benefits relating to sportsmanship, law, and societal good.

Vibration training has been utilized for over forty years, but the potential benefits for athletes has only recently begun to be researched. There is positive evidence that vibration training does indeed enhance speed, power and flexibility for those athletes who utilize it appropriately. For further discussion see, J. Luo, B. McNamara, K. Moran, “The Use of Vibration Training to Enhance Muscle Strength and Power.” 2005:35(1) 23-41.

Russian scientists originally developed the concept of vibration training as a part of their space program. The goal was to provide an exercise regime that would keep the Russian cosmonauts in the best physical condition possible and for extended periods of time while in space. The USSR held numerous endurance records with the assistance of their vibration training technology. Id.

Vibration training technology requires the use of specially designed equipment that vibrates at specific frequencies (normally between 30-50 HZ). Id. The most popular types of vibration training machines or devices are ‘platform-based,’ which allow the user to perform a variety of exercises while standing on, or placing their hands on, a vibrating plate. These vibrating plate machines have several negative features. The machines are large, heavy, and stationary. Once in place in the training area or facility they are virtually unable to be moved easily. Users of these stationary vibration training machines must go to the machine for training. Only a single user can utilize the vibration training machine at a time. Thus, when multiple people are attempting to utilize the machine concurrently, each individual must limit their time with the machine.

One of the most critical aspects of the stationary vibration plate machines is that they utilize a “Total Body Vibration” concept. When seeking specific muscle training while utilizing these total body vibration machines, the user's total body is vibrated in order to get indirect muscle vibration. Total body vibration can have negative side-effects which include dizziness, vertigo, body perception abnormalities, increases in hormone release, possible risk of deep vein thrombosis release resulting in pulmonary embolism, and possible damage to any internal body organ from excessive total body vibration. Certain medical conditions, including pregnancy, are incompatible with the use of a total body vibration machine, thus eliminating a large population of users from the benefits of vibration stimulation training/exercise and the accompanying improved muscle strength, endurance, flexibility, and rehabilitative therapies. Id.

Vibration stimulation training can produce profound physiological effects to the body. Vibration training can recruit the involvement of nearly 100% of a muscle's fibers. This contrasts to the 40-60% of muscle fiber recruitment with traditional resistance training techniques.

Vibration training successfully achieves these 100% muscle fiber recruitment levels by creating an almost continuous stretch/reflex in muscles. This is known as a tonic stretch/reflex and means that while undergoing vibration training, muscles are contracting at incredibly high frequencies, which also subjects them to considerable forces. These vibrational forces are believed to be highly advantageous for the enhancement of fast-twitch muscle fibers. Fast-twitch muscle fibers are responsible for the speed and strength of muscle performance.

Vibration training stimulates muscle blood flow, which can enhance and speed up the recovery of muscles from workouts and rehabilitation from injury. Increased blood flow to affected muscles brings restorative nutrients to muscle cells and helps to clear out or dispose of damaged tissue and toxins associated with inflammation and infection.

Additional research has shown that gender, training status and exercise protocols are moderators of the response to vibration stimulation training for strength development. Based on overall analysis, it is apparent that vibration exercise training can be effective at eliciting chronic muscle strength adaptations. Vibration exercise training can be used by exercise professionals to enhance muscle strength for their athlete or non-athlete clients. Effects of Vibration Training on Muscle Strength: A Metal-Analysis. P. J. Murin & M. R. Rhea. Journal of Strength and Conditional Research. 2010:24(2) 548-556.

Muscular strength represents the ability to generate force and serves as the basis for all human movement. Much research has been devoted to the development of muscular strength with various methods used to stimulate adaptations. Resistance training is presently the most popular way to improve muscle strength and power. Conventional resistance training has involved the use of weights, weight machines, body weight, resistance bands, and other devices designed to provide mechanical resistance. Each form of resistance can result in overload, a point where the neuromuscular system experiences a stress to which it is unaccustomed, and adaptation in the mechanical properties or physiological mechanisms responsible for force generation. Id.

Various reports show that vibration training has a beneficial effect on strength and power enhancement and neuromuscular performance. Russian scientists have combined vibration stimulation and resistance training for decades with proven enhancement in muscle strength, power and endurance. Overall analysis shows it is apparent that vibration stimulation exercise or training elicits chronic power adaptations. Research on the effect of vibration stimulation training on maximal force and flexibility has discovered that vibratory stimulation training yielded an average increase in isotonic maximal strength of 49.8% compared with an average gain of 16% with conventional training. Test results revealed significant pre- and post-training effects and an interaction between pre- and post-training and ‘treatment’ effects for the isotonic maximal force and both flexibility tests utilizing vibration technology. It was concluded that superimposed vibrations applied for short periods allow for increased gains in maximal strength and flexibility. For further discussion of increase in muscle strength see V. B. Issurin, D. G. Liefermann, G. Tenebaum. “Effects of Vibratory Stimulation Training on Maximal Force and Flexibility.” Journal Sports Science. 1994 December:12(6): 562-566.

Additional research indicates that vibration stimulation training has a beneficial acute and/or chronic training effect on strength and power enhancement. The employment of a greater exercise intensity and volume created by a vibratory training program may facilitate a larger enhancement in strength and power. It should be also noted that the method of vibration application will have a significant influence on the vibratory training effect. Direct muscle vibration application having the greatest effect and enhancement on muscle strength and power. See J. Lou, B. McNamara, K. Morak “The Use of Vibration Training To Enhance Muscle Strength and Power.” Journal Sports Medicine. 2005; 35(1): 23-41.

The observed effects of vibration stimulation on muscle(s) depend on various neural facillatory and inhibitory mechanisms. Based on available knowledge about proprioceptive spinal reflexes—that feedback from the primary endings of motor spindles produces a stimulatory effect via increased discharge of a-motor neurons and activation of Golgi tendon organs (GTO) evokes inhibition of muscle action—a hypothesis has been proposed that vibration stimulation training enhances excitatory inflow from muscle spindles to the motor neuron pools and depresses inhibitory impact of GTO due to the accommodation to vibration stimulation. See V. B. Issurin, “Vibrations and Their Applications in Sport. A Review.” Journal Sports Medicine & Physical Fitness. 2005. September:45(3): 324-36.

There is only limited previous disclosures relating to use of vibration to abate or avoid muscle Pain (myalgia), joint pain (arthralgia), and pain originating from connective tissue (fibralgia). Vibration exercise training has previously been shown to prevent and treat delayed-onset muscle soreness (DOMS) associated with athletic training. Research has indicated that vibration exercise training showed a decrease in DOMS symptoms in the form of less maximal iso-metric and iso-kinetic voluntary strength loss, lower creatinine kinase levels, and less pressure pain threshold and muscle soreness compared to the control group. It can be concluded that vibration stimulation training administered before, during and after exercise may reduce DOMS via muscle function improvement. In effect the alleviation of DOMAS suggests that vibration training can effect pain. See A. Aminiam-Far, M. R. Hadian, G. Olyaei, S. Talebian, A. H. Bakhtiary. “Whole-body Vibration and the Prevention and Treatment of Delayed-Onset Muscle Soreness.” Journal Athletic Training 2011 January-February; 46(1) 43-49. None of this research demonstrates how vibration training can be directly applied to a pain center.

“Vibration stimulation of muscles, ligaments and tendons somewhat mimics, to a lesser degree, the effects of Ultrasound therapy used in treatment of muscle, ligament and tendon injuries. Both therapies utilize indirect stimulation of muscle, ligament and tendon tissues. Some of the beneficial effects elicited from Ultrasound therapy can be associated with Vibration therapy to a similar or slightly lesser degree. Ultrasound therapy has been proven to increase blood flow to injured areas, increase healing, increase tissue elasticity, decrease inflammation and thus decrease pain and decrease scar tissue. Vibration therapy can also assist in the improvement of blood flow, decreased inflammation, decreased pain and promote healing process.” What is Ultrasound Therapy? E. Jacques. Chronic Pain. www.About.com. Jan. 6, 2010.

In present practice electrical muscle stimulation and ultrasound therapy are a treatment modalities used to treat pain conditions, and to promote healing. With respect to ultrasound therapy there exist thermal and mechanical methods. Ultrasound therapy utilizes sound waves to penetrate injured tissue. Thermal ultrasound therapy uses a more continuous transmission of sound waves which cause microscopic vibrations in the deep molecules, increasing heat and friction, thereby warming the tissues and theoretically encouraging healing in the soft tissues by increasing the metabolism at the level of the tissue cells. Mechanical ultrasound tissue uses pulses of sound waves to penetrate tissues. This has a minor warming effect on the tissues. Both thermal and mechanical ultrasound are directed towards decreasing the inflammatory response, and reduce tissue swelling. The result of such processes may decrease pain.

Benign Essential Tremor (BET), hereditary tremor, or essential tremor (ET) are neurological conditions that cause symptoms such as rhythmic trembling of hands, head, legs, and trunk, along with vocal disruption. Some patients even report sensations of internal muscle contraction, or “internal shake.” Though ET is eight times more common, it is often confused with Parkinson's Disease. ET affects an estimated 10 million patients in the U.S., with a similar occurrence worldwide. Due to unfortunate stereotypes and lack of patient awareness, many patients experiencing debilitations due to ET never seek medical care. Further discourse regarding ET is found in “Essential Tremor-What the Experts Say,” Essential Tremor Foundation, 2014.

Tremor is an unintentional rhythmic muscle movement involving to and fro movements (oscillations) of one or more body parts. It is the most common of all involuntary movements and can affect the hands arms, head, face, trunk, legs and voice. Most commonly tremors affect the hands, with consequent negative affects on the ability of patients to function in their daily lives. Such tremors commonly occur in otherwise healthy individuals. Although, as such, tremors are not life threatening, they are embarrassing to some patients, and may make it difficult to perform daily tasks of living. Tremor is generally caused by dysfunction in the parts of the brain anatomy that are involved in control of muscle movements in general, or in those parts of the brain responsible for control of certain muscle groups, such as the hands. Tremor may occur at any age, but the most commonly affected patients are middle aged or older. Tremor affects men and women in equal proportion,

Some forms of tremor are genetically controlled and are noted to run in families. As such, Essential Tremor may be passed through repeated generations of families, but may occur in patients with no family history of the disorder. Children of a parent who has experienced Essential Tremor have a 50% chance of inheriting the condition. Recent studies suggest that there is a degeneration of certain parts of the cerebellum in patients with ET. See further discussion at “Essential Tremor, Genetics Home Reference,” National Institutes of Health, 2014, and the references cited therein.

Essential Tremor usually occurs alone, without other neurological signs or symptoms. ET usually occur with movements and can occur during different types of activities, such as eating, drinking, or writing, for instance. The symptoms are not typically exhibited while the patient is at rest. In certain situations, ET is tied to additional symptoms, such as mild balance problems. ET is not shown to shorten the patient lifespan, but patients exhibiting ET have a higher than average risk of developing other neurological conditions, including Parkinson's Disease, or hearing loss, especially in patients developing ET after the age of 65. Such concomitant development of diseases with related symptomology may be indicative of neurological deterioration. There is no cure for most disorders resulting in tremors. Essential Tremor may be treated with drugs, physical therapy or surgery. For additional background on Essential Tremor, see, “What is Tremor?”, National Institute of Neurological Disorders and Stroke, 2014, and the references cited therein.

The above discourse highlights some of the perceived benefits of vibration therapy. Nonetheless, vibration therapy is currently limited to clinical settings and in almost all cases has limited ability to direct vibration therapy to specific muscles, tissues, or pain centers and debilitating spastic neurotransmissions.

There exists a need for a generally available system for individuals to apply vibration therapy to specific targets, both in clinical settings and in casual home use.

### BRIEF SUMMARY

The currently disclosed Vibra-Sleeve™ and Vibra-Wrap™ branded products are non-invasive, non-pharmaceutical, direct muscle vibration training and rehabilitation system devices. The apparatus is also useful for rehabilitation and for use for spastic neurotransmission inhibition. The devices provide users with a portable, flexible apparatus that is lightweight and portable to enhance neurophysiological and musculophysiological performance,and to inhibit debilitating spastic neurotransmission to muscles through the use of a supportive fabric/nylon sleeve or wrap. The devices are intended to improve warm-up or pre-performance training and assist in post-performance rehabilitation and recovery therapy, in addition to the aforementioned inhibition of spastic neurotransmissions. This method can decrease post-performance injuries and delayed-onset muscle soreness (DOMS), while improving actual performance levels and success.

The personal use, portability, and light weight aspects of the products described herein, marketed under the Vibra-Sleeve™ and Vibra-Wrap™ names, are very accessible, convenient, and cost effective methods of direct muscle vibration stimulation training for athletes of all levels. Patients and other individuals afflicted with spastic and uncontrolled neurotransmitted muscle tremors and dyskinesia symptoms resulting from neurological disease or injury similarly benefit from the new system and apparatus.

The system is useful for athletes in both warm and cold weather. The devices can provide for a more safe, thorough and rapid warm-up of muscles for outdoor and cold weather athletes, and can provide indoor and warm weather athletes with necessary muscle warm-up and flexibility, thus lessening the possibility of post-performance muscle stress or injury. The vibrating stimulation sleeve or wrap devices can be directly placed over specific target muscles. The embodiments described herein are most appropriate to be used on muscles of upper or lower extremities, but the method can be adapted for use on other areas, such as shoulders, neck, or head.

An additional benefit of the disclosed system is to direct vibration stimulation to pain centers. The application of directed vibration to specific locations providing pain can alleviate the perception of pain by stimulation of interneurons which block or otherwise inhibit pain in the patient body. In addition, the system and method believed to increase the rate of healing to the target area by increasing blood flow, and thus supplying the healing tissue with enhanced nutrients and elimination of deleterious or toxic byproducts of the healing process.

The device is designed to enhance both acute and chronic muscle performance, strength, power, flexibility, rehabilitation, recovery of muscle and connective tissue, and inhibit or suppress spastic neurotransmission of impulses to target muscles affected by tremor. Traditional, stationary or non-portable total body vibration (TBV) systems are less than desirable due to the excessive distance between the vibrating plate source and affected muscles, and their inability to directly stimulate targeted muscles, joints or pain centers. TBV systems also present the possibility of further injury to muscles or damage to internal organs. The portability of the system devices provides for an easily accessible and affordable non-pharmaceutical, non-invasive method of targeting muscles for vibration training, or muscle tremor suppression, which is not otherwise currently available in the industry.

The method provides vibrational therapy to a user's tissues, including muscles, through a series of vibrational motors contained within the sleeve or wrap. Each sleeve or wrap can support a number of vibrators, and in a preferred embodiment each vibrational device will contain two motor driven stimulators. The vibrations are generated by a motor that rotates an eccentric mass, causing vibration The vibrational motors are powered by a series of power sources housed in a central battery case. The most convenient power source for the device is a series of disc batteries, although artisans will recognize that a variety of power sources are available, including cylindrical batteries. The power source is triggered by the user's engagement of a power switch sitting on top of or near the battery case. The device is operated by a controller that allows the users to vary the vibrational force, and time and duration of vibration application.

Use of direct muscle or extremity vibration technology applications is of great advantage to millions of patients afflicted with Benign Essential Tremors and possibly Parkinson's Disease. Inhibition of the spastic and uncontrolled neurotransmissions to various target muscles, via direct vibrations to affected muscles or extremities, assists in the reduction or amelioration of most, if not all, of the life changing tremor conditions discussed herein.

### BRIEF DESCRIPTION OF THE DRAWINGS

For a fuller understanding of the nature and advantages of the present apparatus, reference should be had to the following detailed description taken in connection with the accompanying drawings, in which:

FIG. 1 is a front elevational view of a sleeve embodiment of the system, with the device's mechanical and electrical components shown in phantom;

FIG. 2 is a rear elevational view of an embodiment of the system using a wrap;

FIG. 3 is front view of the wrap embodiment;

FIG. 4 is a view of the sleeve embodiment as seen when being worn by a user;

FIG. 5 is a perspective view of the sleeve embodiment as seen when not in use by a user;

FIG. 6 is a side view of the sleeve embodiment as seen when being worn by a user;

FIG. 7 is a cross-sectional view of the electrical and mechanical components of the device; and

FIG. 8 is a perspective view of the electrical and mechanical components of the device, shown separate from device's fabric housing.

### DETAILED DESCRIPTION

The present disclosure describes a portable and personal use vibration apparatus enclosed within an elastic fabric/nylon sleeve or velcroed secure wrap. The device may be pulled or wrapped onto a user's arms, shoulders, or legs to provide direct muscle stimulation to enhance muscle strength, power, force, flexibility, rehabilitation, and reduce delayed-onset muscle soreness (DOMS).

The tonic stretch/flex produced by vibration training interacts with the muscle's own contraction frequencies. Fast-twitch muscles contract at a rate of 30-70 times a second when stimulated by traditional heavy load weight training and speed training. By duplicating these fast-twitch muscle contractions with vibration training, these muscle fibers can be worked even harder, thus producing greater muscle fiber recruitment without the enormous “mental” input required by the user/athlete.

No previous system has provided for direct targeting of vibrational stimulation to discrete regions of tissue about a patient body. In a preferred embodiment, the patient body is a human body. Other patients may arise from the animal kingdom, such as athletic mammals, such as horses and dogs. Continued research on the merits of vibration training for both athletes and recreational fitness trainees demonstrates additional benefits of vibration stimulation training. This research suggests that vibration training assists athletes by providing significant improvements in strength, countermovement, jump performance, and flexibility.

Also noted is that fat-free mass also increases following vibration stimulation training. This indicates an increase in muscle mass thus indicating the vibration stimulation training's ability to recruit more muscle fibers, particularly the fast-twitch muscle fibers. With the recruitment of additional fast-twitch muscle fibers during vibration stimulation training, enhancement in muscle strength, power, speed, endurance, and flexibility can be seen.

As described above, research has shown that athletes utilizing vibration stimulation training also benefited from a significant strength increase. This increase was similar to that experienced by people participating in a cardiovascular fitness program. This has led researchers to conclude that the gain in strength for the vibration stimulation training program is comparable to the strength increase following a traditional standard fitness training program consisting of cardiovascular and resistance training techniques. There is strong evidence that vibration stimulation training increases power, strength (isometric and isokinetic) and improves lean muscle mass, in both trained and untrained subjects. Vibration stimulation can have positive benefits for all users. The presently disclosed apparatus and method allow for athletes (including patients) to take advantage of the benefits of vibrational stimulation outside of clinical settings. The portability and highly localized application of the apparatus provides numerous advantages to athletes.

Significant value can be identified in vibration stimulation training by a variety of evidence. Enhanced recovery following intense exercise utilizing vibration technologies has been documented in addition to a reduction in delayed-onset muscle soreness (DOMS). Flexibility and range-of-motion have also been enhanced by use of vibration stimulation during a vibration training program. Acute and chronic muscle strength and power have also been noted to be enhanced utilizing vibration stimulation. Improved muscle activation and eccentric force production are also increased by vibration stimulation training.”

Research studies have indicated that muscle strength and power are most positively affected the closer the vibration stimulus is to the target muscle. The method of direct muscle vibration has the advantage of stimulating the target muscle without vibration signal interruption as found with Total Body Vibration (TBV) devices or machines.”

The present device allows for an individual to provide repetitive vibrational stimulation to the user's muscles. The device provides muscle stimulation through a plurality of battery-powered vibration mechanisms. The vibration mechanisms are encased in the fabric or nylon material of the sleeve or wrap, and attached to a battery supply housing, also contained within the fabric. The device is intended to be powered by removable and replaceable batteries, thus the battery housing can be easily accessed within the fabric. Various sizes of the vibration stimulation devices will be available, so as to account for variations in body sizes of users, as well as size variations of body areas to be targeted. The device can be equally as useful when used with a shoulder-conforming harness support system, to allow for direct vibrational stimulation on shoulder muscles.

The power supply can be configured to be rechargeable, or to allow for connection of an external power source, such as a plug in power supply, or a supplemental battery pack that will fit in a pocket of the user.

An optional synthetic foam pad, namely a buffer pad, can be placed between the outer vibration mechanism and the target muscle site to best distribute the vibrational frequencies directly to the specific target muscles. This thin synthetic foam pad is inserted beneath the vibrating mechanism and inner upper fabric layer. The optional foam pad, vibrating motor mechanism, battery pack, and on/off switch are all secured and enclosed in the flexible fabric/nylon sleeve or wrap.

The fabric/nylon sleeves are open on both ends and enable the user to easily slide the vibration sleeve up and down the target extremity to any 360-degree rotational position or height. Rotation of the vibration stimulation sleeve can provide therapeutic vibration training or rehabilitation to multiple target muscle, tendon, and ligament groups. A single vibration sleeve can be used virtually unlimited number of times on multiple extremities by the user, so long as the batteries are changed as needed. In a preferred embodiment, the proximal opening of the sleeve will have a circumference slightly greater than the distal opening, with the width of the sleeve tapering slightly between the proximal and distal openings of the sleeve. As shown in the accompanying figures, fabric is sewn over the seams on each respective opening of the device.

The vibration stimulation wrap consists of a single length of pre-formed, coiled plastic insert of varying lengths and widths enclosed in a nylon fabric covering with optional Velcro securing straps on each end. The vibrating mechanism, battery pack, and on/off switch are enclosed between the outer nylon fabric covering and inner pre-formed, coiled plastic insert. The ease of application and removal of the vibration stimulation wrap makes it more applicable for those individuals who need to remove the vibration stimulation wrap quickly without the removal of shoes, socks, other apparel, or safety or medical devices such as knee or ankle braces, casts, bandage wraps, etc. The ability to quickly remove the device makes it appropriate for users who intend to engage in athletic activity immediately after use of the vibration stimulation wrap.

The portability of the vibration stimulation sleeve or wrap device makes it accessible anywhere at anytime by the user. The device's light weight and small size increase the ease of use of the device. Traditional Total Body Vibration (TBV) units are very heavy (over 200 pounds) and are virtually unable to be moved easily. Pre-training, training, and post-training applications make the disclosed apparatus and system a portable, individual, and comprehensive muscle training and rehabilitation device that offers universal use for athlete and non-athlete users, and which is compatible with a number of body areas.

Special note should be made that certain medical conditions are incompatible with the use of the vibration stimulation sleeve or wrap. Users with medical conditions such as Raynaud's Disease, which is a neurological/vascular impairment condition of the extremities that is sometimes brought on by or exacerbated by vibrations of the affected site, or Deep Vein Thrombosis (DVT), which is a condition of the formation or existence of blood clots sometimes found in upper or lower extremities, should have medical clearance from the user's personal physician prior to use of the vibration stimulation sleeve or wrap. Use of the vibration stimulation sleeve or wrap could exacerbate the user's medical conditions.

As discussed above, the apparatus and method are useful for inhibiting debilitating spastic neurotransmissions to muscles. The inhibition properties of the method provides for multiple levels of tremor suppression for patients afflicted with Benign Essential Tremors, Parkinson's disease, and additional similar debilitating neurological disease, injury, or insult.

Various modifications and alterations with respect to the vibration mechanism, battery container, on/off switch or other controller, and placement within the fabric/nylon sleeve or wrap design and construction—in addition to any design and performance improvements are envisioned for use with the present system. All designs, drawings and descriptions are illustrative only and should not be considered as limiting the scope of the invention, which is to be given the full breadth of the appended claims and in any an all equivalents thereof.

The system is embodied in an apparatus for delivering direct vibration stimulation to tissues of a patient body. Components of the apparatus may include a controller for regulating the time and intensity of a vibration stimulator, with the controller controlling a pulse rate of the vibration stimulator and an activation time for activating the vibration stimulator. Alternatively, a simple on/off switch may be implemented.

The apparatus is configured with an electrically activated direct vibration stimulator delivery component typically delivering vibration at a rate of between about 10 Hz and 100 Hz, or even more preferably delivering vibrations at about 30-50 Hz. As previously described an apparatus cover contains the vibration stimulation components, with the apparatus cover adapted for securing the apparatus about a location on the patient body, such as about the arms, legs, neck or back.

When in operation the apparatus is situated in relation to the target tissues of the patient body and delivering a predetermined quantity of vibration stimulation to the patient body.

The electrically activated direct vibration stimulator delivery component of is preferably a battery pack contained within the apparatus cover, and a vibration component which is one or more of a motor driven eccentric, a solenoid, and an electromagnet. The electrically activated direct vibration stimulator delivery component may be further configured with an external power supply that is detacheable from the vibration stimulator delivery component.

The apparatus cover is preferably constructed of fabric in an elongated wrap conformation with securing bands allowing the apparatus to be removeably worn on one or more of upper extremities, e.g., the arms, lower extremities, e.g., the legs, neck, and back.

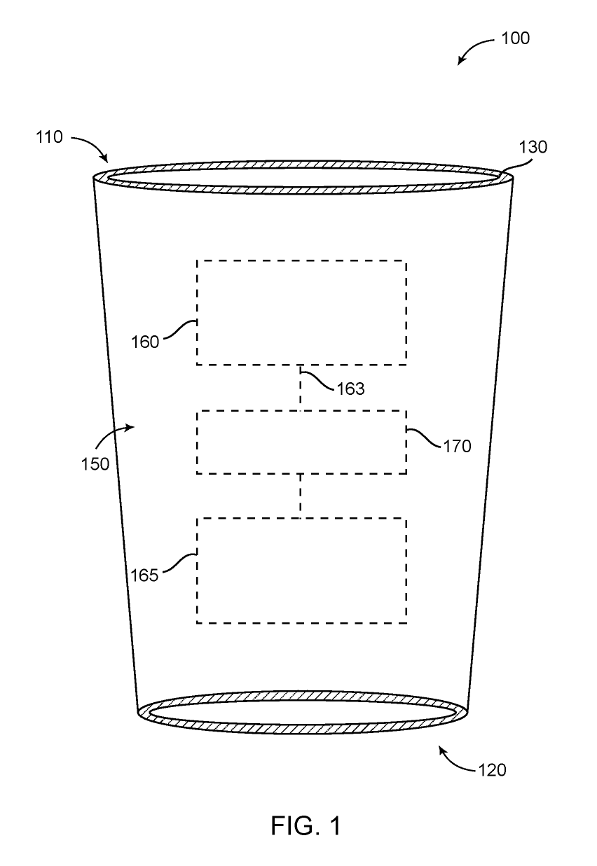

FIG. 1 depicts an embodiment of the system using a sleeve 100. The sleeve is likely to be made of a fabric such as lycra or spandex, which can easily stretch to fit the body of the user. The circumference of the proximal opening of the sleeve 110 is made slightly larger than the distal opening 120, and the width of the sleeve tapers slightly between the proximal and distal openings. A portion of material 130 is sewn over the material along the two openings of the sleeve. This oversewn material provides comfort to the user as the sleeve is being worn. The sleeve is appropriate for use on arms as well as legs. A variety of sizes of the sleeve employing the system will be produced, to account for the varying sizes of users, as well as to provide users with options that are better suited for use with one body part than another.

The material making up the sleeve will encase the mechanical and electrical parts that are employed within the present system. In FIG. 1, a simplified depiction of these components are visible in phantom 150, as they will not be visible from the exterior of the sleeve. The sleeve as shown contains a plurality of vibrational motors 160, 165. These motors will provide the vibrations that allow the user to train and condition his or her muscles. The motors will be powered by a plurality of batteries, which will be contained in a battery housing 170. A variety of power sources can be effectively employed with the present system, as is described below. The power switch for the system will be connected to the battery housing, and is not visible in the figure. The vibration motors are connected to the battery housing and power sources through wiring 163.

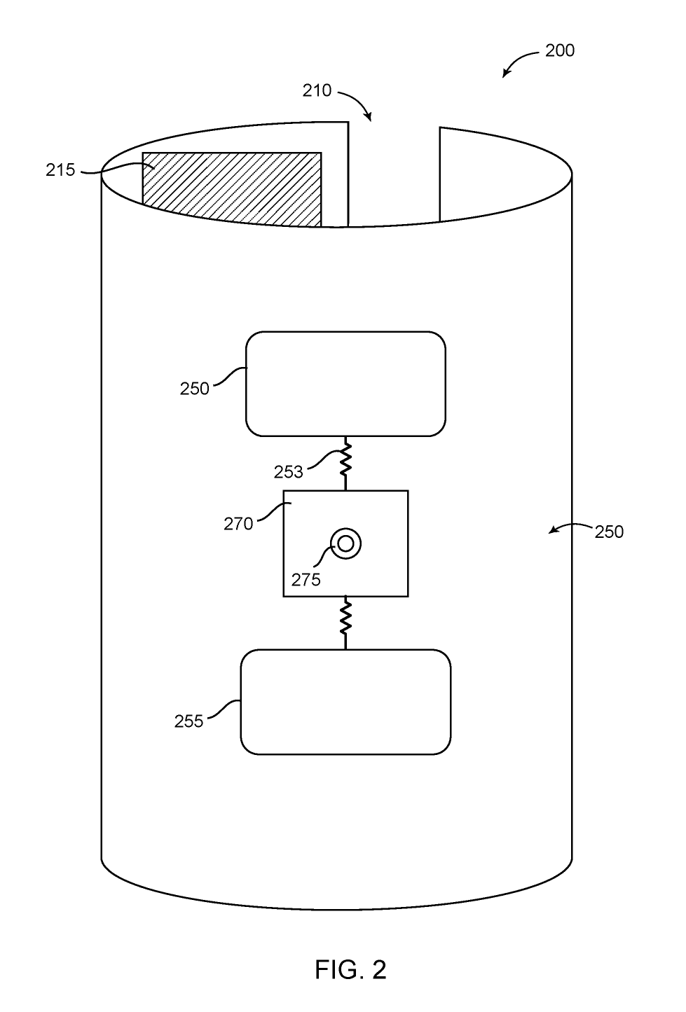

FIG. 2 depicts an embodiment of the present system using a wrap rather than a sleeve 200. The wrap can be made of a similar fabric to the sleeve embodiment, which is described above. The wrap will be secured to the body part of the user through Velcro 215 or another equally effective method. As depicted in the figure, the Velcro at 215 will overlap the material on the opposite extremity of the wrap, thus securing the wrap around the body part of the user.

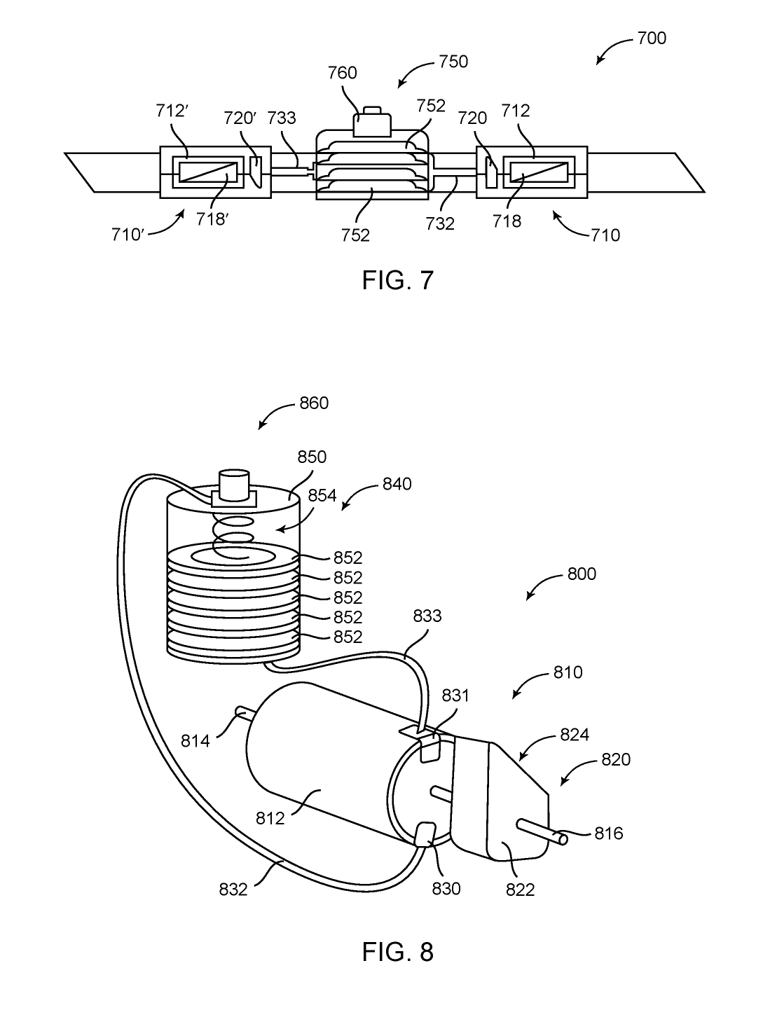

In FIG. 2, simplified depictions of the vibrational motors 250, 255 and the battery housing 270 are visible. The power switch 275 of the system is depicted in the figure as a button. A number of other methods for turning the system on and off can be equally effective. As with FIG. 1, in the active components of the system, including the mechanical and electrical components will be encased by the wrap, and will not be visible from the exterior. The cross section depicted in FIG. 7 is shown as cutting directly through the middle of the components shown in FIG. 2, along line 2-2.

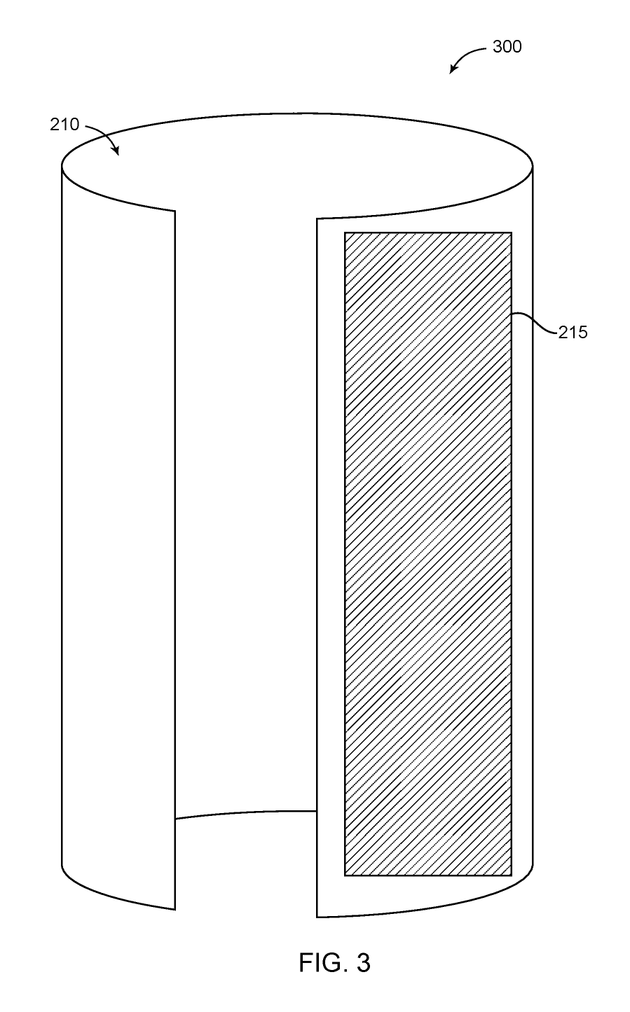

FIG. 3 shows a front view of the wrap embodiment of the system 300. The proximal opening 210 of the wrap is marked, however with the wrap embodiment it is likely that the circumference of the proximal and distal openings will be identical, so that the wrap can be worn in either orientation. The Velcro material 215 used to secure the wrap is depicted. To secure the wrap in this embodiment, the opposite extreme of the wrap is extended over section 215. The mechanical and electrical components of the system are not visible in this figure.

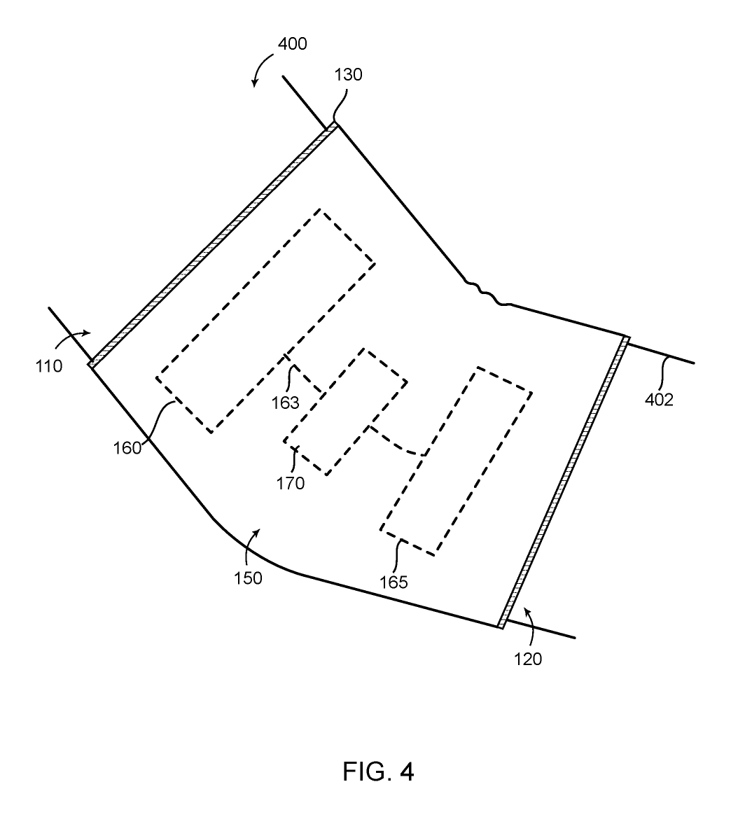

FIG. 4 depicts the sleeve embodiment of the system as it would appear when being worn covering the elbow of a user 400. The wider proximal opening 110 is shown closer to the user's shoulder, while the distal opening 120 is nearer to the forearm. The oversewn material covering the openings is shown at 130.

As with FIG. 1, the electrical and mechanical components are shown in phantom in the drawing. The vibrational motors are depicted at 160 and 165. The battery housing is at 170, with the wiring between the power source and motors shown at 163. The flexibility of the sleeve allows the user to position the vibrational motors over the points where he or she is most in need of vibrational therapy. Though the figure depicts the sleeve covering the user's elbow, the sleeve could likewise be positioned completely over the user's upper arm or forearm.

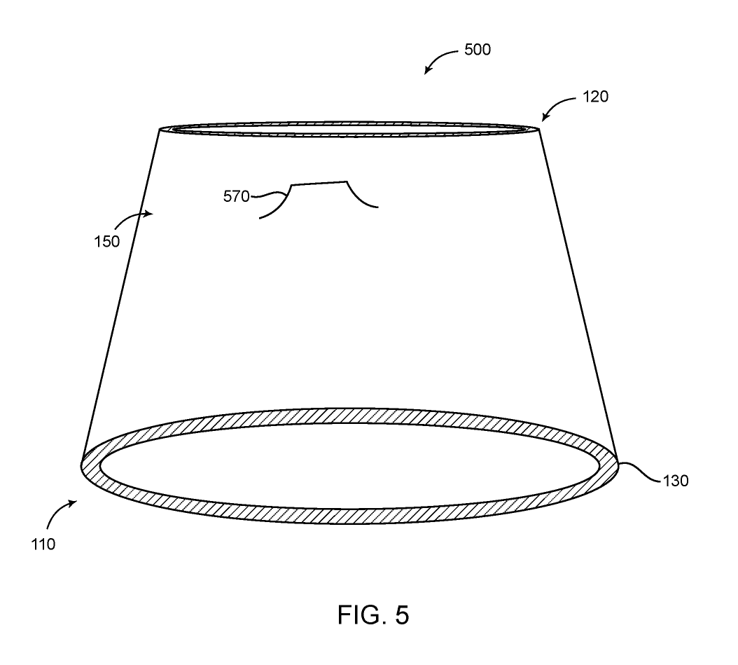

FIG. 5 depicts a perspective view of the sleeve embodiment of the system 500 as it would appear when not being worn, looking at the proximal end of the sleeve. The proximal opening 110 of the sleeve is present in the foreground of the figure, with the oversewn material wrapping over 130 the entirety of the opening. The distal opening 120 is partially visible, with the oversewn material surrounding the opening.

The vibrational motors and battery housing 150 are not visible in FIG. 5. The raised portion at 570, however, shows a possible embodiment of how the system's power switch will appear from the exterior of the device. The battery housing and power switch will be covered by the sleeve fabric in the most likely embodiment of the device, but will be raised slightly. Thus the power switch will appear from the exterior simply as a protrusion on the outside of the sleeve.

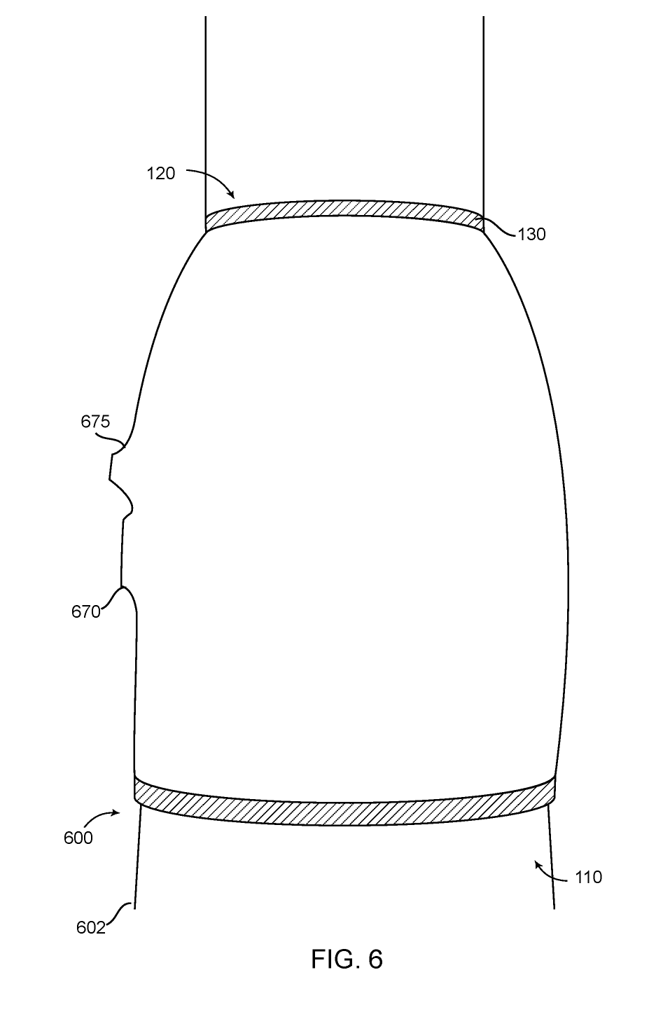

FIG. 6 depicts a side view of the sleeve embodiment of the system 600, as it would appear when being worn by a user. The figure depicts the sleeve being worn on the arm 602 of the user. The proximal opening 110 is shown as being higher up on the arm than the distal opening 120. The side view of the sleeve shows the protrusions of the battery housing 670 and power switch 675 as they are likely to look from the exterior of the sleeve in this embodiment. The system can support a number of different mechanisms to serve as the switch, thus the protrusion of the battery housing and switch may appear differently based on which switch mechanism is chosen.

FIG. 7 depicts a cross-sectional view 700 of the mechanical and electrical components of the system. The cross section is viewed as being through the middle of the mechanical components depicted in FIG. 2. The vibrators of the system are depicted at 710 and 710′. The vibrators are composed of a motor 712 and a vibrational eccentric 720. When power is directed to the motor, the motor shaft rotates, spinning the eccentric and causing the vibrations that provide the user with vibrational therapy.

The battery housing is shown at 750, with the case of the housing shown in phantom so that the inner components are visible. As described above, the system can operate effectively using a variety of power sources. In FIG. 7, the system is depicted using a series of disc batteries 752 to power the system. Disc batteries are commonly known as watch batteries for the commonality of their use in wristwatches. Disc batteries are likely the most appropriate power sources for the present system because they minimize the size of the battery housing, thus making the housing as unobtrusive and comfortable for the user as possible. However, other small batteries, such as AAA batteries, may also be implemented in the present system. The system power switch is depicted at 760. The switch is this embodiment is shown as a button switch. The wiring harnesses at 732 and 733 provide power to the motors from the power sources.

In a further embodiment of the disclosure the switch component further comprises an integrated circuit timing and frequency controller. Thus, a controller is provided for regulating the time and intensity of a vibration stimulator. The controller regulates a pulse rate of the vibration stimulator, for instance by varying the voltage applied to a motor driving an eccentric, or to a solenoid type vibrator, or by switching the application of power to regulate the vibration rate. A feedback sensor can be implemented to monitor the vibration rate, and feedback to the controller as to the actual vibration frequency. The vibration frequency can be in the range of about 10-100 Hz, for example, or within a narrower range of about 30-50 Hz.

In addition the controller can be implemented to program start and stop time, i.e. an activation time parameter, for activating the vibration stimulator. Such timing may regulate the length of time the vibration stimulator is active, or to periodically activate the stimulator based on a projected therapeutic program.

FIG. 8 depicts a detailed rendering of the battery housing and one of the vibrators 800 of the system. The vibrator 810 is comprised of the vibrational motor 812 and the vibrating eccentric 820. A motor shaft 814 runs through the interior of the motor, and extends past the eccentric 816. When power is provided to the power source, the motor shaft is made to rotate, thus rotating the out-of balance eccentric and causing the vibrations.

The eccentric creates its vibrations through its asymmetrical shape. One side of the eccentric, the “heavy side” 822, is shaped as a rectangular prism, while the opposite side, the “light side” 824, is shaped as a triangular prism. The weight differential between the heavy side and light side causes vibrations to be produced as the rotation of the motor delivers force from the heavy side, and releases such force on the light side. A variety of shapes and sized of eccentric can be used with the system. In one embodiment, DC power is applied to the motor at a range of voltages, altering the force applied and the frequency of vibrations delivered.

Those skilled in the art will recognize that a variety of modulating electrical components can be used to deliver vibrations, such as a electromagnetically driven buzzer, plunger or solenoid.

The vibrator is wired to the power supply 840 through a series of wiring harnesses 832, 833. The wiring is connected to the vibrator's motor at 830 and 831. The power supply housing is comprised of a battery pack 850 and a power switch 860. The battery pack as depicted housing a plurality of disc batteries 852. As described above, other batteries or alternative power sources can also be equally effective with the present system. A battery contact spring is contained within the battery pack at 854. Engagement of the power switch 860 signals power to be directed to the system's vibrators. In the present figure the power switch is depicted as a push-button switch, however other switches, including toggle switches or slide switches, can also be used effectively with the system.

As the disclosure is applied to a variety of physical conditions or diseases, a value in patient outcome is predicted. Additional research contemplated according to the disclosure, utilizing the vibra-sleeve and vibra-wrap device in a variety of methods adapted by those skilled in the art is predicted to provide further benefits to patients experiencing neurological illnesses, conditions, or due to injury or insult to tissue, including to muscle, connective tissues or neurological tissues.

This disclosure describes and teaches a new invention that is not obvious nor suggested by known relevant art. While the invention has been described with reference to preferred embodiments, those skilled in the art will understand that various changes may be made and equivalents may be substituted for the various elements without departing from the scope of the invention. In addition, many modifications may be made to adapt a particular situation or material to the teachings of the invention without departing from its essential scope. It is intended that all matter contained in the above descriptions and examples or shown in the accompanying drawings shall be interpreted as illustrative and not in a limiting sense. In this application all units are in the metric system and all amounts and percentages are by weight, unless otherwise expressly indicated. All terms not specifically or by implication defined in the disclosure are considered to be defined according to Webster's New Twentieth Century Dictionary Unabridged, Second Edition, or Dorland's Medical Dictionary. The disclosures of all of the citations referenced within this disclosure are expressly incorporated by reference. The disclosed invention advances the state of the art and its many advantages include those described and claimed.

I claim:

1. A non-invasive method of enhancing muscle tissue performance in a patient, said method comprising the steps;
applying a direct vibration stimulation apparatus delivery system incorporating to a target muscle;
said apparatus providing battery pack, a controller system and one or more vibration motors, said vibration motors delivering vibrations at a frequency of about between 30-50 Hz;
said battery pack, controller system and the one or more vibration motors being contained in an elastic fabric sleeve or wrap, said sleeve or wrap being able to be transferred, secured or worn on one or more of upper and lower extremities;
activating direct vibration simulation of specific neuromusculoskeletal tissues for an interval sufficient to provide a therapeutic benefit,
said benefit including one or more of providing improved acute muscle performance, improved chronic muscle performance, improved post-training rehabilitation, decrease in post-training delayed-onset muscle soreness, decreased tremor activity, improved motor ability, inhibition of spastic neurotransmitted muscle tremor, and decreased spastic muscle movement.

2. An apparatus for delivering direct vibration stimulation to tissues of a patient body comprising
a controller for regulating the time and intensity of a vibration stimulator, said controller controlling a pulse rate of the vibration stimulator and an activation time for activating the vibration stimulator;
an electrically activated direct vibration stimulator delivery component delivering vibration at a rate of between about 10 Hz and 100 Hz; and
an apparatus cover containing the vibration stimulation components, said apparatus cover adapted for securing the apparatus about a location on the patient body
said apparatus provided for applying to the tissues of the patient body and delivering a predetermined quantity of vibration stimulation to the patient body.

3. The electrically activated direct vibration stimulator delivery component of claim 2 further comprising a battery pack contained within the apparatus cover, and a vibration component which is one or more of a motor driven eccentric, a solenoid, and an electromagnet.

4. The electrically activated direct vibration stimulator delivery component of claim 2 further comprising an external power supply that is detacheable from the vibration stimulator delivery component.

5. The electrically activated direct vibration stimulator delivery component of claim 2 further comprising a vibration component which is a motor driven eccentric.

6. The electrically activated direct vibration stimulator delivery component of claim 2 further comprising imposing from the apparatus functional, direct vibration simulation of specific neuromusculoskeletal systems during pre-performance and post-performance training;

7. The apparatus of claim 2 further comprising the electrically activated direct vibration stimulator delivery component delivering vibrations at about 30-50 Hz.

8. The apparatus of claim 2 further comprising the cover constructed of fabric in an elongated wrap conformation with securing bands allowing the apparatus to be removeably worn on one or more of upper extremities, lower extremities, neck, and back.

9. The apparatus of claim 8 further comprising the electrically activated direct vibration stimulator delivery component which is a motor driven eccentric.

10. A method of alleviating pain in a patient body comprising
applying an apparatus for delivering direct vibration stimulation to tissues of the patient body further comprising
a controller for regulating the time and intensity of a vibration stimulator, said controller controlling a pulse rate of the vibration stimulator and an activation time for activating the vibration stimulator;
an electrically activated direct vibration stimulator delivery component delivering vibration at a rate of between about 10 Hz and 100 Hz, said vibration stimulator delivery component being one or more of a motor driven eccentric, a solenoid, and an electromagnet;
an apparatus cover containing the vibration stimulation components, said apparatus cover adapted for securing the apparatus about a location on the patient body;
a battery pack contained within the apparatus cover;
applying the apparatus to one or more of upper extremities, lower extremities, neck, and back of the patient body;
programming the controller to activate the vibration stimulator delivery component for a determinable period of therapy;
allowing the application of direct vibration simulation to specific neuromusculoskeletal systems that are potential location of pain origination; and
continuing to deliver direct vibration stimulation to tissues for such time as to be determined to provide therapeutic benefit.

11. The method of claim 10 further comprising the electrically activated direct vibration stimulator delivery component delivering vibrations at about 30-50 Hz for a period of about 30 minutes.

12. The method of claim 10 further comprising a buffer pad under the vibration stimulator delivery component.

13. The method of claim 1 further comprising implementing the method for neurophysiological or musculophysiological muscle pre-performance warm-up.

14. The method of claim 1 further comprising implementing the method for improvement of post-performance muscle rehabilitation and recovery in specific target muscles in athletes through direct vibration stimulation of specific target muscles.

15. The method of claim 1 further comprising activating the apparatus during pre-performance and post-performance training.

16. The method of claim 1 further comprising providing a therapeutic benefit for inhibition of spastic neurotransmitted muscle tremor, or decreased spastic muscle movement.

17. The method of claim 1 further comprising providing a therapeutic benefit for decreased tremor activity.

18. The method of claim 1 further comprising providing a therapeutic benefit of providing improved post-training rehabilitation, or decrease in post-training delayed-onset muscle soreness.
